(19) United States
(12) Patent Application Publication
(10) Pub. No.: US 2007/0000658 A1
(43) Pub. Date: Jan. 4, 2007

(54) Assembly arrangement for an air conditioning unit

(75) Inventors: Evripidis Koukouravas, Neckartenzlingen (DE); Gebhard Schweizer, Leonberg (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/560,362

(22) PCT Filed: May 19, 2004
(86) PCT No.: PCT/EP04/05418

§ 371 Date: Apr. 27, 2006

(30) Foreign Application Priority Data
Jun. 13, 2003 (DE) 103 27 120.1

(51) Int. Cl. B60H 3/00; B60H 1/00

(52) U.S. Cl. 165/202; 165/42; 165/43

(57) ABSTRACT

The invention relates to an assembly arrangement for an air conditioning unit, in particular, for a motor vehicle, comprising at least one housing, at least one first device for the exchange of heat, at least one second device for the exchange of heat, at least one inlet, for a particularly gaseous medium, at least one outlet for the particularly gaseous medium and at least one flow regulation device. The housing comprises at least one assembly arrangement for at least one further modular device.

The present invention relates to an assembly arrangement for an air conditioning unit, in particular for a motor vehicle.

Air conditioning units have long been known in the prior art and are used as standard equipment or additional accessories in various motor vehicles. In the prior art, air conditioning units of this type have at least two apparatuses for the exchange of heat, one being used to cool the air and one being used to, heat the air. In addition, depending on the area of use, various other devices may also be present. For example, more or fewer different zones of the motor vehicle are air-conditioned depending on the type of vehicle. In some cases, one, two, two and a half, three or four zones of the motor vehicle are air-conditioned. This gives rise to the problem whereby in each case different air conditioning units have to be provided depending on the vehicles in which the air conditioning unit is used, which increases the structural outlay and therefore leads to increased costs.

The invention is therefore based on the object of providing an assembly arrangement for an air conditioning unit which can be used in a very wide range of types of vehicle without the configuration of the unit having to be altered at high structural outlay or cost.

According to the invention, this is achieved by the subject matter of claim 1. Advantageous embodiments form the subject matter of the subclaims.

The invention relates to an assembly arrangement for an air conditioning unit, in particular for a motor vehicle, having at least one housing, at least one first apparatus for the exchange of heat, at least one second apparatus for the exchange of heat, at least one inlet for an in particular gaseous medium, at least one outlet for the in particular gaseous medium and at least one flow control device. In this arrangement, the housing has at least one receiving device for at least one further modular device.

The in particular gaseous medium is in particular the air that is to be heated or cooled and is ultimately to be passed into the interior of the vehicle.

A flow control device is to be understood as meaning a device which regulates and/or controls the quantitative flow and/or the direction of flow. Therefore, by way of example air flaps are understood as flow control devices in the sense of the invention.

A receiving device is to be understood as meaning a region of the housing in which the modular device is arranged. This region may be spatially delimited by walls which are matched to a specific shape of the modular device. Furthermore, the receiving device may have securing devices for fixing the modular device.

The securing device may be configured in such a way that the entire modular device can be accommodated in it or in the housing. However, the modular device may also project beyond the boundaries of the housing.

In a preferred embodiment of the invention, the receiving device is substantially formed by recessing a predetermined part of the outer surface of the housing.

A modular device is to be understood as meaning either an individual component or a plurality of components which have been assembled to form one unit and at least serve a common purpose.

In a preferred embodiment, the at least one further modular device has at least one device which influences the medium.

The device which influences the medium is preferably a device from a group which includes apparatuses for the exchange of heat and/for flow control devices and/or flow guide devices and/or outlets.

A flow guide device is to be understood as meaning a device which guides a flow, in particular an air flow, on a predetermined path at least in sections, such as for example an air duct or the like.

The modular device is preferably used to adapt the air conditioning unit to differing requirements and/or to enable a different number of zones within a vehicle to be air-conditioned. For example, 2-zone, 2½-zone, 3-zone or 4-zone controls are conceivable. In the context of the present invention, 2-zone control is to be understood as meaning that a selected region of the vehicle interior, for example the front part of the passenger compartment, can be air-conditioned separately for the driver side and the passenger side.

A 2½-zone control is to be understood as meaning that in addition to the abovementioned front region a further region, such as for example the back region, can be partially controlled, in particular cooled.

In the case of 3-zone control, the back region can be completely controlled or air-conditioned as well as the front region.

The term 4-zone control is to be understood as meaning that as well as the front region the back region can also be controlled or air-conditioned separately for the left-hand and right-hand sides.

In another preferred embodiment, the first apparatus for the exchange of heat is an evaporator. In this case, this evaporator forms part of a refrigeration circuit.

In a further preferred embodiment, the second apparatus for the exchange of heat is a heating apparatus. In this case, this heating apparatus can heat the air flow through it on either the air side or the water side. In this context, the term on the air side is to be understood as meaning that the heating of the air is controlled substantially on the basis of the quantity of air which passes through the heating device. In this case, the quantity of the refrigerant which flows through the heating device remains substantially constant.

The term heating on the water side is to be understood as meaning that the temperature or warming of the air is substantially regulated and/or controlled by the quantity and/or temperature of the refrigerant passed through the heating apparatus.

In another preferred embodiment, there is at least one third apparatus for the exchange of heat, the third apparatus for the exchange of heat being selected from a group of apparatuses which includes electrical heating elements, fuel-operated heating elements, CO₂ heat pumps, heating systems which utilize exhaust-gas heat, evaporators, condensers, heaters for when the vehicle is stationary, electrical heating systems, PTC heating systems, heat exchangers and the like.

In another preferred embodiment, at least one flow control device is provided in the outlet. This can used to control and/or regulate the quantity of air passed into the interior of the vehicle.

In another preferred embodiment, at least one flow control device is arranged upstream of the second apparatus for the exchange of heat, as seen in the direction of flow of the air. It is preferable for a multiplicity of flow control devices to be arranged upstream of the second apparatus for the exchange of heat, as seen in the direction of flow of the air. In this context, the direction of flow of the air is to be understood as meaning the direction in which the air at least in sections, propagates in a predetermined section. In this context, minor changes in direction, for example caused by turbulence, can be disregarded.

In another preferred embodiment, the second and third apparatuses for the exchange of heat are arranged adjacent to one another. It is preferable for the second and third apparatuses for the exchange of heat to be arranged parallel to one another. In this context, the term arranged parallel is to be understood as meaning that two planes which run through the second and third apparatuses and are defined by the two main directions of extent of the apparatus are parallel to one another. In this context, the second and third apparatuses for the exchange of heat are preferably in touching contact with one another.

In another preferred embodiment, the housing has at least one flow guide, by which the gaseous medium, i.e. the air, is made to at least partially bypass the second apparatus for the exchange of heat. It is in this way possible to prevent the air from passing through the heating device if cooling of the air is all that is desired.

In another preferred embodiment, at least one apparatus for the exchange of heat, preferably the heating device, has two flow paths for a refrigerant which are separate from one another at least in sections.

For this purpose, at least one apparatus for the exchange of heat has at least two feeds for the refrigerant. This means that the refrigerant is passed through two separate paths in a predetermined region of the apparatus for the exchange of heat.

It is preferable for the refrigerant to be discharged from the at least two flow paths that are separate from one another in sections via a common discharge line.

In another preferred embodiment, a control device which controls the flow of the refrigerant within the apparatus for the exchange of heat through the apparatus for the exchange of heat is provided in at least one feed and/or discharge line for the refrigerant.

In another preferred embodiment, the at least two flow paths for the refrigerant, within the apparatus for the exchange of heat, are arranged in different spatial sections of the apparatus of the exchange of heat. This means that the individual flow paths are not arranged alternately in sections, but rather, for example, one flow path is arranged entirely on a predetermined section of the apparatus for the exchange of heat, and the other or further flow path is arranged in a further section of the apparatus for the exchange of heat. In addition, it is also possible to provide more than two flow paths, such as for example three flow paths, which are guided in separate sections of the apparatus for the exchange of heat.

The invention is also directed at an air conditioning unit, in particular for a motor vehicle, which has an assembly arrangement of the type described above.

Further advantages and embodiments of the present invention will emerge from the appended drawings, in which:

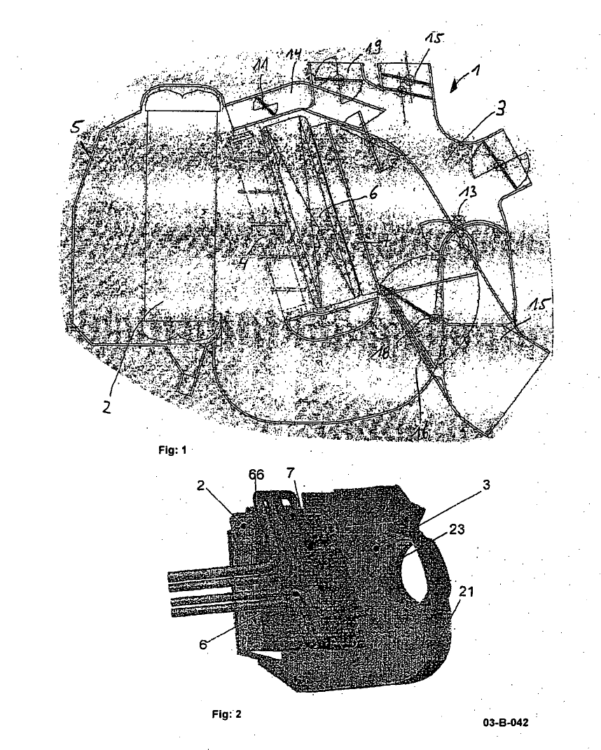

FIG. 1 diagrammatically depicts an assembly arrangement according to the invention;

FIG. 2 shows a perspective illustration of an assembly arrangement according to the invention;

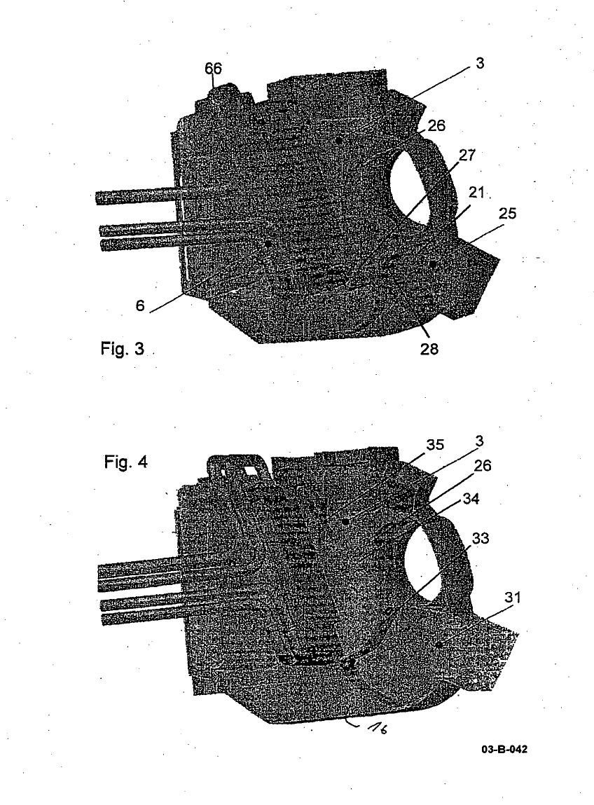

FIG. 3 shows a perspective illustration of another embodiment of an assembly arrangement according to the invention;

FIG. 4 shows a perspective illustration of another embodiment of an assembly arrangement according to the invention;

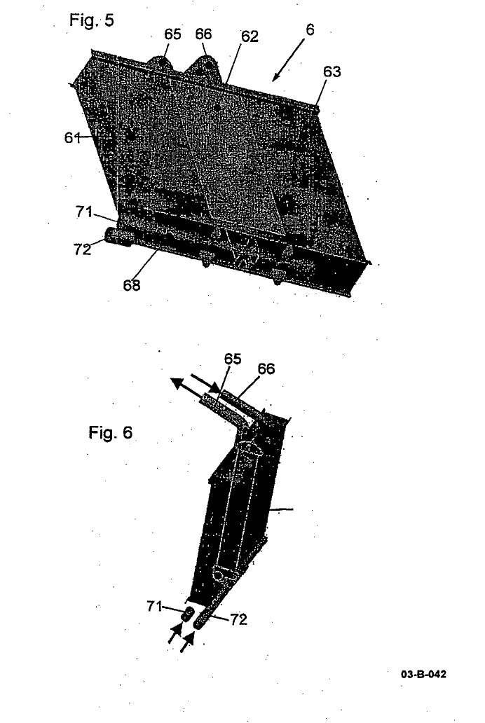

FIG. 5 shows a perspective illustration of a heating apparatus for an assembly arrangement according to the invention;

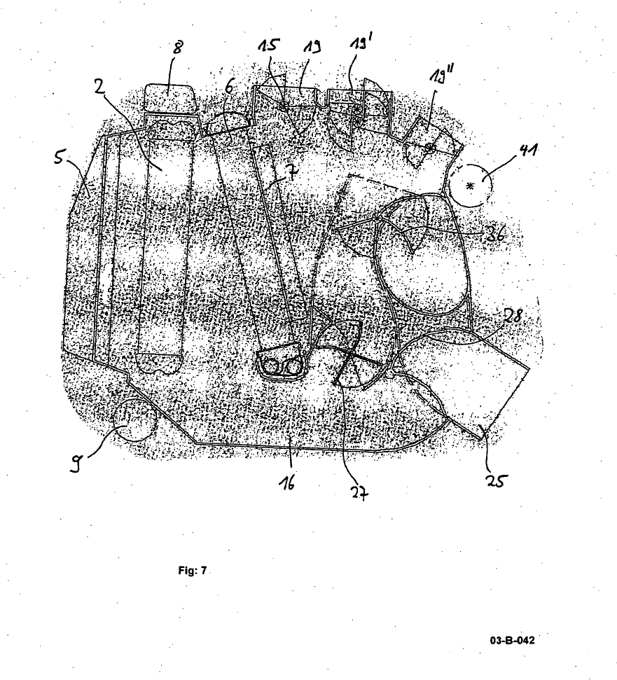

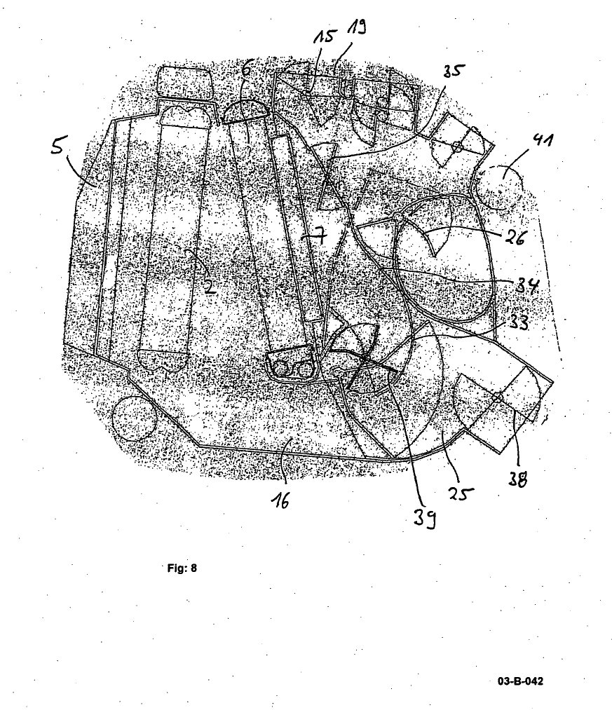

FIG. 6 shows another perspective illustration of the heating apparatus from FIG. 7;

FIG. 7 diagrammatically depicts a preferred embodiment of an assembly arrangement according to the invention;

FIG. 8 diagrammatically depicts another embodiment of an assembly arrangement according to the invention.

FIG. 1 diagrammatically depicts an assembly arrangement 1 according to the invention for an air conditioning unit, in particular for a motor vehicle.

Reference numeral 2 denotes an evaporator which is arranged downstream of the air inlet 5 as seen in the direction of flow of the air. The width of the evaporator is between 100 mm and 400 mm, preferably between 200 mm and 300 mm and particularly preferably between 230 mm and 290 mm. The height of the evaporator is between 100 mm and 400 mm, preferably between 180 mm and 280 mm and particularly preferably between 210 mm and 270 mm.

The depth of the evaporator is between 20 mm and 150 mm, preferably between 30 mm and 100 mm and particularly preferably between 50 mm and 80 mm.

The evaporator has a grid surface area of between 2 dm² and 10 dm² and preferably between 3 dm² and 8 dm² and particularly preferably between 4.5 dm² and 6 dm².

A filter (not shown) is arranged upstream of the evaporator, as seen in the direction of flow.

The width of this filter is between 104 mm, preferably between 200 mm and 300 mm and particularly preferably between 220 mm and 270 mm. The height of the filter is between 100 mm and 400 mm, preferably between 200 mm and 300 mm and particularly preferably between 220 mm and 260 mm.

The depth of the filter is between 10 mm and 90 mm, preferably between 20 mm and 70 mm and particularly preferably between 30 mm and 40 mm. The grid surface area of the filter is between 2 dm² and 10 dm², preferably between 4 dm² and 8 dm² and particularly preferably in the region of 6 dm².

Reference numeral 4 denotes a multiplicity of flow control devices which are arranged upstream of the heating device 6 and downstream of the evaporator 2, as seen in the direction of flow of the air. In this context, it is preferable to provide a multiplicity of individual control devices, which can be controlled and/or regulated in particular, although not exclusively, by motors in order in this way to control and/or regulate a supply of air to the heating device 6. The second apparatus for the exchange of heat 6 is in this figure a heating device. The apparatus for the exchange of heat 6 has a width of between 100 and 400 mm, preferably between 120 and 35.0 mm and particularly preferably between 250 and 320 mm.

The height of the apparatus 6 is between 100 and 400 mm, preferably between 180 and 280 mm and particularly preferably between 210 and 260 mm.

The depth of the apparatus 6 for the exchange of heat 6 is between 10 and 70 mm, preferably between 20 and 60 mm and particularly preferably between 25 and 40 mm.

The grid surface area of the apparatus 6 for the exchange of heat is between 2 and 8 dm², preferably between 3 and 7 dm² and particularly preferably between 4.5 and 5 dm².

A third apparatus for the exchange of heat 7, which in this embodiment is a PTC heating element, directly adjoins the apparatus for the exchange of heat 6. The width of this PTC element is between 100 mm and 400 mm, preferably between 120 mm and 250 mm and particularly preferably between 140 mm and 180 mm.

The height of this third apparatus 7 for the exchange of heat is between 100 mm and 300 mm, preferably between 150 mm and 260 mm and particularly preferably between 180 and 230 mm. The depth of this third apparatus for the exchange of heat 7 is between 5 and 30 mm, preferably between 10 and 20 mm and in particular in the region of 15 mm.

Reference numeral 14 denotes an air flow duct with a flow control device 11 arranged in this air flow duct.

Reference numeral 19 denotes an outlet of the air, and reference numeral 15 denotes a flow control device arranged in a further outlet. The individual outlets 19 may lead into different regions of the interior of the motor vehicle, such as for example the front footwell or the rear footwell, onto the front windscreen or to ventilation ducts provided in the dashboard.

Reference numeral 3 denotes the housing in which the individual apparatuses for the exchange of heat and the control devices are accommodated. Reference numeral 16 relates to a flow duct for the air, which is arranged beneath the apparatus 6 for the exchange of heat.

If the flow control devices 4 prevent the air from passing through the heating device 6, at least some of the air will flow through this flow path 16. The flow of the air through the flow duct 16 can be controlled and/or regulated by means of a flow control device i.e. an air flap 18. The surface area of this flow path 16 is between 0.5 dm² and 4 dm², preferably between 1 dm² and 2 dm²₁ and particularly preferably in the region of 1.5 dm².

Reference numeral 15 denotes another device according to the invention which is accommodated in the housing 3. This is in this case a two-zone module, in order for two separate zones of the vehicle interior to be supplied with conditioned air. Reference numeral 13 denotes a flow control device which controls and/or regulates the flow rate into the two-zone module 15.

FIG. 2 shows a perspective view of an assembly arrangement according to the invention. In this figure, reference numeral 6 once again refers to the apparatus for the exchange of heat and reference numeral 7 to the third apparatus for the exchange of heat, which by way of example may be a PTC heating element. Reference numeral 3 denotes the housing, it being possible for modular devices to be arranged in the region or the receiving device 21. Reference numeral 66 refers to a feed or discharge line for a refrigerant flowing through the apparatus for the exchange of heat 6. Reference numeral 2 denotes an evaporator.

A flow control device, for example, may be fitted in the region 23 of the housing 3.

FIG. 3 shows another perspective illustration of an assembly arrangement according to the invention. Unlike in the case of the arrangement shown in FIG. 2, a modular device 25 has now been inserted into the region or the receiving device 21. In addition, there is now a flow control device 26.

Reference numeral 27 relates to a flow control device, by means of which the air which is made to bypass the apparatus for the exchange of heat 6 can be controlled and/or regulated. The air which enters through the modular device 25, and/or the quantity of this air, can be controlled and/or regulated by means of a further flow control device 28.

FIG. 4 shows a perspective illustration of another embodiment of the assembly arrangement according to the invention. The flow control device 33 is used to control and/or regulate the proportions of the air which have passed through the duct 16 and the proportions which passes through the apparatus 6 for the exchange of heat and to pass them onto the modular device 31.

The modular device 31 is used to air-condition two back zone's, resulting overall in 4-zone air conditioning.

FIG. 5 shows a second apparatus for the exchange of heat for an assembly arrangement according to the invention. This apparatus has three flow sections 61, 62 and 63. A refrigerant is passed within each of these sections, with the individual flows being separate from one another at least in sections. This refrigerant may, for example, be water from the cooling circuit of a motor vehicle.

To achieve separate guidance of the refrigerant within the apparatus 6, there are three feeds 66, 71 and 72 which in each case pass the refrigerant into the corresponding regions 62, 61 and 63.

These feeds 66, 71 and 72 can be of any desired geometric cross sections, for example rectangular, polygonal, circular or elliptical as well as mixed forms thereof. In the present embodiment, the tube diameter is between 5 mm and 20 mm, preferably between 10 mm and 20 mm and particularly in the region of 15 mm. In the present embodiment, the sections 61 and 63 are controlled on the water side and the region 62 is controlled on the air side. For this purpose, feeds 71 and 72 have control devices (not shown) which control and/or regulate the quantity of the refrigerant flowing through the sections 61 and 63. By contrast, in section 62 the quantity of refrigerant flowing through this section is substantially not controlled, but rather the temperature control is implemented using the quantity of air flowing through this section. The refrigerant is discharged from the apparatus 6 from all the sections 61, 62 and 63 together via the discharge line 65. The discharge line 65 has a tube diameter of between 8 and 30 mm, preferably between 12 and 24 mm and particularly preferably in the region of 18 mm.

FIG. 6 shows the apparatus for the exchange of heat 6 from FIG. 7 in a further perspective illustration. In addition to the arrangement of the feeds and discharge lines shown here, it is also possible to provide other arrangements. For example, the discharge line could also run parallel to the apparatus or have a plurality of curved sections.

Reference numeral 69 relates to a through-flow device, through which the refrigerant flows on its flow path between the feed line 66 and the discharge line 65. In the central section, the refrigerant first of all flows downwards in a subregion of the through-flow device 69 and then flows back upwards to the discharge line 65 in a second subregion.

However, this is not an imperative configuration; by way of example, it would also be possible for the through-flow devices to be configured in such a way in the regions 61 and 73 that the refrigerant first of all flows through the apparatus in a first direction and then in a direction which is opposite to this first direction.

Through-flow devices (not shown) are also provide in sections 61 and 63. Here, however, unlike in the through-flow device 69, the refrigerant substantially flows in only one direction, i.e. from the feeds 71 or 72, respectively, in the direction of the discharge line 65.

FIG. 7 diagrammatically depicts an assembly arrangement according to the invention in a corresponding way to the perspective illustration presented in FIG. 3. Air enters the arrangement according to the invention in the region denoted by 5. In particular, although not exclusively, cables, for example for the cockpit cabling, can be routed in the region denoted by 8.

However, it is also possible for cables to be routed into the region denoted by 9.

Reference numeral 6 shows the second apparatus for the exchange of heat. In the sectional illustration shown in FIG. 7, it is possible to recognize the section 62 of the apparatus 6, i.e. the section which is controlled on the air side. The sections 61, 63 which are in each case controlled on the water side are located above and below the plane of the drawing, starting from the figures.

Reference numeral 27 denotes a flow control device which controls the supply of air from the region 16. The flow control device 28 controls the supply of air into the modular device 25. The flow control device 36 controls the supply of air into selected regions of the interior of the vehicle, such as in this case for example the footwell in the front and in the rear. Reference numeral 15 denotes a further flow control device, and reference numeral 19 denotes a further outlet for the air.

In this embodiment, the outlet 19 is used to defrost the windshield; the outlet 19′ or the outlets 19′ lead to nozzles arranged on the left-hand side and right-hand side of the dashboard and the outlet 19″ leads to a center nozzle preferably arranged in the center of the dashboard.

FIG. 8 diagrammatically depicts an assembly arrangement according to the invention which partially corresponds to the perspective arrangement shown in FIG. 4.

Reference numeral 5 denotes the air entry into the assembly arrangement according to the invention, and reference numeral 2 denotes the evaporator. Cables for the motor vehicle cockpit can be routed in the regions 8 or 9.

The reference numeral 19 represents an outlet in which a flow control device 15 is arranged. Reference numeral 7 denotes a third apparatus for the exchange of heat, such as in particular, although not exclusively, a PTC heating element.

The air stream into individual outlets such as for example into a defrosting duct, can be controlled or regulated by means of the flow control device 35. FIG. 8 also shows the middle section 62 of the apparatus 6 for the exchange of heat.

A support, for example, for the arrangement according to the invention may be arranged in the region 41. Reference numeral 26 refers to a flow control device which controls and/or regulates the air stream which passes into the footwell of a motor vehicle. The reference numeral 34 denotes a flow duct for the air which adjoins the apparatus 6 for the exchange of heat on its section 62. This illustration clearly reveals that the air which passes from the apparatus 6 for the exchange of heat into the modular device 25 substantially originates from the section 62 of the apparatus 6 for the exchange of heat. Since the modular device 25 is used to air-condition the back region of the vehicle, the result is that in this embodiment the back region is substantially air-conditioned by the air-side section 62 of the apparatus 6 for the exchange of heat.

Reference numeral 33 refers to a further control device for the air. The air which originates from the duct 16 can be controlled and/or regulated by means of this flow control device and/or the flow control device 39. In this embodiment, the flow control device 38 is not arranged in the same plane as, for example, the flow control device 39, but rather is arranged behind it.

1. An assembly arrangement for an air conditioning unit, in particular for a motor vehicle, having at least one housing, at least one first apparatus for the exchange of heat, at least one second apparatus for the exchange of heat, at least one inlet for an in particular gaseous medium, at least one outlet for the in particular gaseous medium and at least one flow control device, characterized in that the housing has at least one receiving device for at least one further modular device.

2. The assembly arrangement as claimed in claim 1, characterized in that the at least one further modular device has at least one device which influences the medium.

3. An assembly arrangement, in particular the assembly arrangement as claimed in claim 1, wherein the device which influences the medium is selected from a group of devices which influence the medium comprising apparatuses for the exchange of heat and/or flow control devices and/or flow guiding devices and/or outlets.

4. An assembly arrangement, in particular the assembly arrangement as claimed in claim 1, wherein the first apparatus for the exchange of heat is an evaporator.

5. An assembly arrangement, in particular the assembly arrangement as claimed in claim 1, wherein the second apparatus for the exchange of heat is a heating apparatus.

6. An assembly arrangement, in particular the assembly arrangement as claimed in claim 1, wherein at least one third apparatus for the exchange of heat, the third apparatus for the exchange of heat being selected from a group of apparatuses which includes electrical heating elements, fuel-operated heating elements and the like.

7. An assembly arrangement, in particular the assembly arrangement as claimed in claim 1, wherein at least one flow control device in each outlet.

8. An assembly arrangement, in particular the assembly arrangement as claimed in claim 1, wherein at least one flow control device is arranged upstream of the second apparatus for the exchange of heat, as seen in the direction of flow of the air.

9. An assembly arrangement, in particular the assembly arrangement as claimed in claim 1, wherein the second apparatus and the third apparatus for the exchange of heat are arranged adjacent to one another.

10. An assembly arrangement, in particular the assembly arrangement as claimed in claim 1, wherein the second apparatus and the third apparatus for the exchange of heat are arranged parallel to one another.

11. An assembly arrangement, in particular the assembly arrangement as claimed in claim 1, wherein the housing has at least one flow guide, by which the gaseous medium is at least partially made to bypass at least the second apparatus for the exchange of heat.

12. An assembly arrangement, in particular the assembly arrangement as claimed in claim 1, wherein at least one apparatus for the exchange of heat has at least two flow paths, which are separate from one another at least in sections, for a refrigerant.

13. An assembly arrangement, in particular the assembly arrangement as claimed in claim 1, wherein at least one apparatus for the exchange of heat has at least two feeds for a refrigerant.

14. An assembly arrangement, in particular the assembly arrangement as claimed in claim 1, wherein the refrigerant is discharged from the at least two flow paths, which are separate from one another at least in sections, via a common discharge line.

15. An assembly arrangement, in particular the assembly arrangement as claimed in claim 1, wherein a control device which controls the flow of the refrigerant through the apparatus for the exchange of heat is provided in at least one feed or discharge line for the refrigerant.

16. An assembly arrangement, in particular the assembly arrangement as claimed in claim 1, wherein at least two flow paths for the refrigerant, within the apparatus for the exchange of heat, are arranged in different spatial sections of the apparatus for the exchange of heat.

17. An air conditioning unit, in particular for a vehicle, which has at least one assembly arrangement as claimed in claim 1.
